(19) United States
(12) Patent Application Publication
(10) Pub. No.: US 2006/0189497 A1
(43) Pub. Date: Aug. 24, 2006

(54) Wood preservative

(76) Inventor: Earl Jenevein, Robert, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/402,689

(22) Filed: Apr. 11, 2006

Related U.S. Application Data
(63) Continuation-in-part of application No. 10/780,077, filed on Feb. 17, 2004, now Pat. No. 7,045,492.
Application No. 10/780,077 is a continuation-in-part of application No. 10/610,032, filed on Jun. 30, 2003, now Pat. No. 7,026,274.
Application No. 10/610,032 is a continuation-in-part of application No. 10/351,880, filed on Jan. 27, 2003, now Pat. No. 6,720,297.
Application No. 10/351,880 is a continuation-in-part of application No. 10/208,232, filed on Jul. 30, 2002, now Pat. No. 6,511,950.

(51) Int. Cl. C11D 3/37

(52) U.S. Cl. 510/189

(57) ABSTRACT

A wood preservative composition for treating wood to impart biocide and antimicrobial characteristics to wood contains a mixture of one or more cleaning members containing quaternary salts, an aromatic quaternary salt, a copper sulfate, a glycol ether and a chelator, mixed with water. The preferred active members are tetradecyltrimethylammonium bromide, tetrasodium ethylenediaminetetraacetic acid, benzethonium hydrochloride, copper sulfate pentahydrate and 2-butoxyethanol. The chelator is tetrasodium salt ethylenediamine of tetraacetic acid (EDTA).

### CROSS-REFERENCE TO RELATED APPLICATIONS

This application is a continuation-in-part of a co-pending application Ser. No. 10/780,077, filed on Feb. 17, 2004, entitled “Cleaning Composition and a Method of Making Thereof,” which is a continuation-in-part of co-pending application Ser. No. 10/610,032 filed on Jun. 30, 2003, entitled “A Cleaning Composition for Neutralizing Biological and Chemical Weapons Removal Agents,” now U.S. Pat. No. 7,026,274, which is a continuation-in-part of application Ser. No. 10/351,880 filed on Jan. 27, 2003 entitled “A Cleaning Composition,” now U.S. Pat. No. 6,720,297, which is a continuation-in-part of application Ser. No. 10/208,232 filed on Jul. 30, 2002 entitled “A Cleaning Composition,” now U.S. Pat. No. 6,511,950, the full disclosures of which are incorporated by reference herein and priority of which is hereby claimed.

### BACKGROUND OF THE INVENTION

The present invention relates to a wood preservative, and, more particularly, to a composition containing copper and a detergent for use in the preservation of wood.

Because of its increased resistance to rot and infestation, preservative-treated wood has been widely used for many residential applications, including decks, outdoor furniture, wood foundations, and a host of other purposes. Pressure-infused preservatives in lumber, plywood and other wood-based products add decades to the predicted service life of these materials in exterior applications, especially where ground contact is required. Chromated copper arsenate (CCA) is the preservative used in about 90% of the pressure-treated materials sold through 2001. CCA has been effective in protecting wood products from mold and insects; it is also economical. However, the chromium and arsenic used in playground furniture and residential applications have also generated concerns over possible health risks from exposure, contact or chemical leaching. Some concerns have also been expressed on the possible health risks from saw dust generated when cutting or milling CCA-treated wood.

In February of 2002, the Environmental Protection Agency (EPA) announced a voluntary decision by the wood-treating industry to phase out the use of CCA preservatives for residential building products by the end of 2003. The EPA does not permit the manufacture of materials containing CCA for residential use after 2003. Several manufacturers have already developed arsenic- and chromium-free preservatives, marketing them as low-toxicity alternatives to traditional treated lumber. One of such composition is alkaline copper quaternary (ACQ). A practical problem with ACQ treated wood is that leached copper causes a galvanic electrolytic reaction with metal fasteners used in the manufacture of wood products and shortens their lifetime.

The present invention contemplates elimination of drawback associated with the prior compounds and provision of an effective wood preservative that is safe for use in industrial and residential applications and that is relatively inexpensive to manufacture.

### SUMMARY OF THE INVENTION

It is an object of the present invention to provide a wood preservative composition that can be used in treating wood to protect the wood against mold and insects.

It is another object of the present invention to provide a wood preservative that has a high flash point so as to substantially decrease the possibility of igniting the products made from wood that has been treated with the composition of the present invention.

It is a further object of the present invention to provide a method of making a wood preservative composition that can be used in large lumberyards and other industrial facilities.

These and other objects of the present invention are achieved through a provision of saturated solution of a wood preservative, which comprises one or more quaternary ammonium salts, sulfates, chlorides or bromides. More specifically, the cleaning composition comprises tetradecyltrimethylammonium bromide, benzethonium hydrochloride, tetrasodium ethylenediaminetetraacetic acid, copper sulfate pentahydrate and 2-butoxyethanol dissolved in water.

The wood preservative composition of the instant invention further comprises a chelator, such as for instance edetate sodium and more specifically, tetrasodium salt (tetrasodium edetate) of ethylenediamine tetraacetic acid (EDTA).

### DETAILED DESCRIPTION OF THE PREFERRED EMBODIMENT

Preservatives are infused into wood by applying vacuum to remove air from the porous structure and then high pressure to perfuse the preservative into the structure. Wood is a composite of cellulose, hemicellulose, lignin, and terpenoid materials that are resinous in nature. The microhoneycomb interior of wood contains many anionic site formed from the phenolic hydroxyls of the polyphenols present and lignin as well as acidic carboxylate group on aromatic acids. The present invention provides a composition that comprises copper (II) and a detergent that facilitates penetration of copper into the wood fibers. When a heavy metal such as copper (II) chelated with ethylenediaminetetraacetic acid is injected under high pressure and heat in solution with a cationic detergent such as an aromatic quaternary ammonium compound/alkyl quaternary ammonium mixture plus a glycol ether non-ionic detergent the copper (II) ion is carried deeply into the wood matrix structure.

The copper (II) ion is a strong biocide, active against fungi, bacteria, and boring insects such as termites. The quaternary ammonium compounds used in the instant composition are also antimicrobial but in a different way than the copper (II) ion. The copper (II) binds to the cell walls of the fungi and inhibits transport of vital nutrients to the fungus. The detergent quaternary ammonium compounds occupy key anionic sites on the surface of the fungus and assist in dissolution of the cellular structure of the fungal mycelium.

The composition of the instant invention is not alkaline after the copper sulfate is added (its pH is 5.55) the detergent composition before copper is added has a pH of 10.5.

The wood preservative composition of the instant invention contains a copper (II) salt, chlorides and bromides as the active ingredients. The preferred embodiment of the present wood preservative composition comprises one or more aromatic quaternary ammonium compounds, one or more quaternary ammonium compounds, one or more copper salts, and a glycol ether dissolved in water. An optional dye may be added to impart coloring to the treated wood. The copper salt is preferably copper sulfate, and even more preferably copper sulfate pentahydrate; its chemical formula is CuSO₄.5H₂O. Copper sulfate pentahydrate is available in a granular form. In the preferred embodiment, the composition comprises between 0.2 and 2% by weight of the copper sulfate.

The quaternary ammonium compounds have a surfactant quality which has a detergent like property, disrupting cell membranes, and they are also bacteriostatic or bacteriocidal depending on the concentrations used.

The bromides and chlorides are selected from the group consisting of tetradecyltrimethylammonium bromide, myristyltrimethylammonium bromide, tetrasodium ethylenediaminetetraacetic acid, benzethonium chloride, benzethonium hydrochloride, PEG-6 lauramide, stearalkonium chloride, cocoamidopropylamine oxide, cetrimonium chloride, dodecyltrimethylammonium chloride (trimethyl-1-dodecanaminium chloride, lauryl trimethyl ammonium chloride).

Other suitable salts may include one or more of the following: cetamine oxide, lauramine oxide, dipalmitoylethyl hydroxyethylammonium methusulfate, elalkonium chloride, lauramine oxide, myrystamine oxide, stearamine oxide, cocamidopropyl betaine, cetyl dimethyl betaine, hydrogenated cocamidopropyl betaine, laurylamidopropyl betaine, polyglyceryl-10 decaoleate propylene, propylene glycol/dicaprylate/dicaprate, caprylic/capric triglyceride, lauramide DEA, cocamide DEA, cocamide MEA, lauramide MEA, cocamide MIPA, coco diethanolamine, butoxy ethyl stearate, distearyl phthalic acide amide, di-hydrogenated tallow phthalic acid, sodium stearyl phthalamate.

The wood preservative composition comprises a mixture of long-chain cation-forming organic compounds that may be found in quaternary ammonium salts and aromatic quaternary ammonium compounds. Mixtures of quaternary ammonium salts and aromatic quaternary ammonium salts can be used. Specific examples of suitable quaternary ammonium salts are odecyltrimethylammonium bromide (or chloride), tetradecyltrimethylammonium bromide (or chloride), hexadecyltrimethylammonium bromide (or chloride), octadecyltrimethylammonium bromide (or chloride), cetyltrimethylammonium bromide (or chloride), cetylbenzyldimethylammonium chloride, cetyltrimethylammonium bromide, and mixtures thereof.

In one of the preferred embodiments, the present invention provides for the use of the quaternary ammonium salt tetradecyltrimethylammonium bromide (myristyltrimethylammonium bromide), which is sold under a variety of names, for instance, Morpan T, mytab, tetradonium bromide, quaternium 13, trimethylmyristylammonium bromide. Molecular formula of tetradecyltrimethylammonium bromide is C.sub.17H.sub.38BrN. The physical data of tetradecyltrimethylammonium bromide: it is white powder with a melting point of between 245 to 250 degrees C. It is stable, incompatible with strong oxidizing agents, corrosive (may cause bums if handled improperly) and may damage mucous membranes. However, the preferred embodiment of the instant composition contains between about 0.2% to about 2.00% by weight of tetradecyltrimethylammonium bromide or other quaternary salt and consequently is safe.

Examples of the aromatic quaternary ammonium salts for use in the present invention include dodecyltrimethylammonium chloride (trimethyl-1-dodecanaminium chloride, lauryl trimethyl ammonium chloride), benzethonium hydrochloride, or N,N-Dimethyl-N-[2-[2-[4-(1,1,3,3-tetramethylbutyl)phenoxy]ethoxy]ethyl]benzene-methanaminium chloride; benzyldimethyl[2-[2-(p-1,1,3,3-tetramethylbutylphenoxy)ethoxy]ethyl]ammonium chloride. Benzethonium hydrochloride is very soluble in water, producing a foamy, soapy solution. It is soluble in alcohol, acetone and chloroform. In the preferred embodiment, the wood preservative composition provides for the use of between about 0.2% to about 2.00% by volume of benzethonium chloride.

The chelator used in the wood preservative composition may be edetate sodium and more specifically, tetrasodium salt (tetrasodium edetate) of ethylenediaminetetraacetic acid 98% (EDTA). EDTA has a molecular formula of N,N-1,2-Ethanediylbin[N-(carboxymethyl)glycine]tetrasodium salt; (ethylenedinitrilo)tetroacetic acid tetrasodim salt. It is usually sold as a powder, which is readily soluble in water. The tetrasodium salt is a stable substance; if it is burned it may produce carbon monoxide, carbon dioxide or nitrogen oxides. In the preferred embodiment, the wood preservative composition provides for the use of between about 0.2% to about 2.00% by weight of EDTA.

The wood preservative also comprises a glycol ether, more specifically 2-butoxyethanol in the preferred range of between about 0.05% to about 1.5% by weight. 2-butoxyethanol is available under the names of ethylene glycol monobutyl ether, ethylene glycol butyl ether, ethylene glycol n-butyl ether, Butyl Cellosolve, butyl glycol, and butyl Oxitol and others. Its molecular formula is C.sub.4H.sub.9OCH.sub.2CH.sub.2OH. It is a clear colorless liquid that is used as a solvent in spray lacquers, enamels, varnishes, and latex paints and as an ingredient in paint thinners and strippers, varnish removers, and herbicides. It is also used in liquid soaps, cosmetics, industrial and household cleaners, and dry-cleaning compounds.

The basic wood preservative composition of the preferred embodiment comprises tetradecyltrimethylammonium bromide, benzethonium chloride, tetrasodium ethylenediaminetetraacetic acid, copper sulfate pentahydrate, and 2-butoxyethanol dissolved in water. Optionally, the composition further comprises a trace dye methylene green dye.

In the preferred embodiment, the wood preservative composition comprises equal amounts of tetradecyltrimethylammonium bromide, tetrasodium ethylenediaminetetraacetic acid, copper sulfate pentahydrate, and benzethonium hydrochloride, of between about 0.2% and about 2.00% by weight each, and between about 0.05 and about 1.5% of 2-butoxyethanol dissolved in water. Optionally the wood preservative further comprises a trace amount of a dye.

The wood preservative is odorless, stable, with specific gravity of 1.04 and pH of 10.0. If no dye is added, the liquid has a blue color.

The preparation procedure of the cleaning composition of the present invention comprises the steps of making a separate solution of copper sulfate in water, and a separate solution of water and other solids with the nonionic detergent. The two solutions are mixed immediately before use at the wood treatment site. After mixing the two solutions in a reactor, a dye may be dissolved in the reactor to give the wood preservative compound a characteristic tint that penetrates the wood and imparts the “pressure-treated” coloration to the untreated wood product. The resultant product is translucent and has no undissolved particles. It is applied to the wood product under pressure so as to cause the compound to deeply penetrate into the wood fibers and this protect the wood product from mold, fungi and insects.

The mechanism for the bacteriostatic or bacteriocidal action of the instant composition is not well understood. It is believed that the key ingredients in the cleaning composition of the present invention are long chain fatty alkyl quaternary ammonium compounds. They are efficient synthetic detergents, which use the hydrophobic or non-polar “tails” of their long carbon chains help penetration of copper sulfate in the wood fibers. Copper sulfate, in turn, is believed to disrupt outer cells of wood-destroying organisms, as a result of which the organisms die. The detergent ingredients of the present invention serve as a vehicle to promote a much greater penetration of copper sulfate through the wood cells, thus protecting products made from the wood treated with the instant composition.

From the foregoing description, one skilled in the art can easily ascertain the essential characteristics of the invention defined in this specification and the appended claims, and without departing from the spirit and scope thereof can make various changes and modifications of the invention to adapt it to various usages and conditions. Such changes and modifications as would be obvious to one skilled in the art are intended to be included within the scope of the following claims.

We claim:

1. A wood preservative composition, comprising: one or more member selected from the group consisting of tetradecyltrimethylammonium bromide, myristyltrimethylammonium bromide, tetrasodium ethylenediaminetetraacetic acid, benzethonium chloride, benzethonium hydrochloride, PEG-6 lauramide, stearalkonium chloride, cocoamidopropylamine oxide, cetrimonium chloride, dodecyltrimethylammonium chloride, tetradecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammonium bromide, cetamine oxide, lauramine oxide, dipalmitoylethyl hydroxyethymmonium methusulfate, elalkonium chloride, lauramine oxide, myrystamine oxide, stearamin oxide, cocamidopropyl betaine, cetyl dimethyl betaine, hydrogenated cocamidopropyl betaine, laurylamidopropyl betaine, polyglyceryl-10 decaoleate propylene, propylene glycol/dicaprylate/dicaprate, caprylic/capric triglyceride, lauramide DEA, cocamide DEA, cocamide MEA, lauramide MEA, cocamide MIPA, coco diethanolamine, butoxy ethyl stearate, distearyl phthalic acide amide, di-hydrogenated tallow phthalic acid, sodium stearyl phthalamate, butyl glycol, and mixtures thereof, a copper salt, and a chelator dissolved in water.

2. The composition of claim 1, wherein said composition comprises at least one copper salt, a detergent and a chelator.

3. The composition of claim 1, wherein said chelator comprises edetate sodium.

4. The composition of claim 3, wherein said edetate sodium is tetrasodium salt of ethylenediamine tetraacetic acid.

5. The composition of claim 1, comprising at least tetradecyltrimethylammonium bromide, benzethonium chloride, tetrasodium ethylenediaminetetraacetic acid, copper sulfate pentahydrate and 2-butoxyethanol dissolved in water.

6. The composition of claim 1, comprising equal amounts of tetradecyltrimethylammonium bromide, tetrasodium ethylenediaminetetraacetic acid, and benzethonium hydrochloride, of between about 0.2% and about 2.00% by weight each, between about 0.05% and about 1.5% by weight of 2-butoxyethanol dissolved in water.

7. A wood preservative composition, comprising: effective amounts of one or more members selected from the group consisting of tetradecyltrimethylammonium bromide, tetradecyltrimethylammonium chloride, myristyltrimethylammonium bromide, tetrasodium ethylenediaminetetraacetic acid, benzethonium chloride, benzethonium hydrochloride, PEG-6 lauramide, stearalkonium chloride, cocoamidopropylamine oxide, cetrimonium chloride, dodecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammmonium bromide, cetamine oxide, lauramine oxide, dipalmitoylethyl hydroxyethymmonium methusulfate, elalkonium chloride, lauramine oxide, myrystamine oxide, stearamin oxide, cocamidopropyl betaine, cetyl dimethyl betaine, hydrogenated cocamidopropyl betaine, laurylamidopropyl betaine, polyglyceryl-10 decaoleate, propylene, propylene glycol/dicaprylate/dicaprate, caprylic/capric triglyceride, lauramide DEA, cocamide DEA, cocamide MEA, lauramide MEA, cocamide MIPA, coco diethanolamine, butoxy ethyl stearate, distearyl phthalic acide amide, di-hydrogenated tallow phthalic acid, sodium stearyl phthalamate, butyl glycol, copper sulfate and mixtures thereof, and edetate sodium, dissolved in water.

8. The composition of claim 7, comprising equal amounts of tetradecyltrimethylammonium bromide, tetrasodium ethylenediaminetetraacetic acid, copper sulfate hydrochloride, and benzethonium chloride, of between about 0.2% and about 2.00% by weight each, between about 0.05% and about 1.5% by weight of 2-butoxyethanol, dissolved in water.

9. A wood product treated with a wood preservative composition of claim 1.

10. A method of preparing a wood preservative composition to impart biocide and antimicrobial characteristics to wood, comprising the steps:
a. admixing and dissolving in water a pre-determined quantity of a copper sulfate;
b. admixing and dissolving in water a pre-determined quantity of one or more wood-penetrating agents selected from the group consisting of tetradecyltrimethylammonium bromide, tetradecyltrimethylammonium chloride, myristyltrimethylammonium bromide, tetrasodium ethylenediaminetetraacetic acid, benzethonium chloride, benzethonium hydrochloride, PEG-6 lauramide, stearalkonium chloride, cocoamidopropylamine oxide, cetrimonium chloride, dodecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammmonium bromide, cetamine oxide, lauramine oxide, dipalmitoylethyl hydroxyethymmonium methusulfate, elalkonium chloride, lauramine oxide, myrystamine oxide, stearamin oxide, cocamidopropyl betaine, cetyl dimethyl betaine, hydrogenated cocamidopropyl betaine, laurylamidopropyl betaine, polyglyceryl-10 decaoleate, propylene, propylene glycol/dicaprylate/dicaprate, caprylic/capric triglyceride, lauramide DEA, cocamide DEA, cocamide MEA, lauramide MEA, cocamide MIPA, coco diethanolamine, butoxy ethyl stearate, distearyl phthalic acide amide, di-hydrogenated tallow phthalic acid, sodium stearyl phthalamate, butyl glycol; and
c. retaining the copper sulfate solution and the wood-penetrating agents solution separately until immediately prior to treating wood.

11. The method of claim 10, further comprising a step of adding a pre-determined amount of chelator to the step of dissolving said one or more wood-penetrating agents.

12. The method of claim 11, wherein said chelator is edetate sodium.

13. A wood product comprising a quantity of wood treated with the mixture of claim 10.

14. A composition obtained by the method of claim 10, wherein said mixture of one or more wood-penetrating agents comprises a mixture of tetradecyltrimethylammonium bromide, tetrasodium ethylenediaminetetraacetic acid, benzethonium hydrochloride and 2-butoxyethanol.

15. The composition of claim 14, comprising equal amounts of tetradecyltrimethylammonium bromide, tetrasodium ethylenediaminetetraacetic acid, copper sulfate hydrochloride, and benzethonium chloride, of between about 0.2% and about 2.00% by weight each, between about 0.05% and about 1.5% by weight of 2-butoxyethanol, dissolved in water.

16. A wood preservative composition comprising a substance obtained by the method of claim 10.

17. A method of treating wood to impart biocide and antimicrobial characteristics to wood, comprising the steps:
a. admixing and dissolving in water a pre-determined quantity of a copper sulfate;
b. admixing and dissolving in water a pre-determined quantity of one or more wood-penetrating agents selected from the group consisting of tetradecyltrimethylammonium bromide, tetradecyltrimethylammonium chloride, myristyltrimethylammonium bromide, tetrasodium ethylenediaminetetraacetic acid, benzethonium chloride, benzethonium hydrochloride, PEG-6 lauramide, stearalkonium chloride, cocoamidopropylamine oxide, cetrimonium chloride, dodecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammmonium bromide, cetamine oxide, lauramine oxide, dipalmitoylethyl hydroxyethymmonium methusulfate, elalkonium chloride, lauramine oxide, myrystamine oxide, stearamin oxide, cocamidopropyl betaine, cetyl dimethyl betaine, hydrogenated cocamidopropyl betaine, laurylamidopropyl betaine, polyglyceryl-10 decaoleate, propylene, propylene glycol/dicaprylate/dicaprate, caprylic/capric triglyceride, lauramide DEA, cocamide DEA, cocamide MEA, lauramide MEA, cocamide MIPA, coco diethanolamine, butoxy ethyl stearate, distearyl phthalic acide amide, di-hydrogenated tallow phthalic acid, sodium stearyl phthalamate, butyl glycol;
c. admixing the aqueous solution of copper sulfate with the aqueous solution of wood-penetrating agents into a quantity of water sufficient to constitute 100% by volume after said one or more wood-penetrating agents is added; and
d. immediately applying the resultant mixture, under pressure to wood.

18. The method of claim 16, further comprising a step of adding a pre-determined amount of chelator to the step of dissolving said one or more wood-penetrating agents.

19. The method of claim 17, wherein said chelator is edetate sodium.

20. A wood product comprising a quantity of wood obtained by the method of claim 16.
